(19) United States
(12) Patent Application Publication
(10) Pub. No.: US 2004/0152788 A1
(43) Pub. Date: Aug. 5, 2004

(54) Uniform emulsion by membrane emulsification

(76) Inventors: Huey Shen Wu, Newark, DE (US); Takahiro Oga, Tsukubo-gun (JP); Shinzo Omi, Tokyo (JP); Naohiro Yamazaki, Tokyo (JP)

Correspondence Address: W. L. Gore & Associates, Inc., 551 Paper Mill Road, P.O. Box 9206, Newark, DE, 19714-9206, US

(21) Appl. No.: 10/356,216

(22) Filed: Jan. 31, 2003

(51) Int. Cl. B01F 17/00

(52) U.S. Cl. 516/9

(57) ABSTRACT

Uniform emulsions of fluorinated liquid droplets in water are formed from SPG (Shirasu porous glass) membrane emulsification. The fluorinated oil-in-water emulsions exhibit unusually stability, as the much denser fluorinated liquid droplets do not coalesce at least 3 month after emulsification. A subsequent polymerization of monomer mixtures of the fluorinated droplets yields uniform polymeric microspheres encapsulating the fluorinated fluid. The use of expanded PTFE membrane emulsification forms water-in-oil emulsions with uniform liquid droplets, especially when small amount of fluorinated liquid is present in the oil phase.

### BACKGROUND OF THE INVENTION

Emulsions and emulsification techniques are widely used in food processing, medicine, cosmetics, pigment dispersions and synthesis of latex. High shear equipment such as homogenizers and stirred vessels have been employed for the preparation of fine emulsions and dispersions. Recently, low shear and energy saving membrane emulsification processes have emerged as a handy and manageable method, attracting investigators working in the above fields.

The principle of membrane emulsification is illustrated in FIG. 11. One of two immiscible liquids (dispersion phase 100) is extruded through the pores 101 of membrane 102. Droplets 103 released from membrane 102 are dispersed in the continuous phase 104. If pores 101 have an adequately narrow size distribution, uniform droplets can be obtained by carefully controlling the pressure driving dispersion phase 100.

Three kinds of membranes have been reported as used in membrane emulsification: ceramic membranes, porous glass membranes, and polymer films. An important requirement for the membrane is that the membrane should be thoroughly wetted by the continuous phase so that direct contact of the membrane with the dispersion phase may be minimized during the emulsification. Fouling of the membrane by the dispersion phase must be avoided during emulsification in order to maintain a reasonably narrow size distribution of the droplets. Sophisticated pre-treatments and maintenance of the membranes may be essential; this requirement can be a major disadvantage when commercial applications are considered.

The use of ceramic membranes has been discussed in several references. As for ceramic membranes, Collins and Bowen [Collins, S. E.; Bowen, R. W; Membrane Emulsification Using Microporous, Ceramic Membranes. Second World Congress on Emulsion, Bordeaux, France, Sep. 23-26, 1991, Abstracts and Extended Papers of Theme 1, Vol. 1, 1997, 1-2-215-219] used micro-filtration ceramic membranes (0.2 micrometer pore) and ultra-filtration membranes (30,000 MW cut off) for the preparation of sunflower oil-in-water emulsions. The micro-filtration membrane yielded emulsions with broader size distributions, while droplets of 2 micrometer average diameter with narrower size distribution were obtained using ultra-filtration membranes. Schroeder et al. [Schroeder, Behrend, 0., Schubert, H. Effect of Dynamic Interfacial Tension on the Emulsification Process Using Microporous Ceramic Membrane, J. Colloid Interface Sci. 1998, 202, 334-340] used cylindrical ceramic membranes (alpha-Al₂O₃, 0.1 and 0.8 micrometer pores) for the emulsification of vegetable oil-in-water. They showed that the shear stress on the membrane surface or membrane pores did not exceed 190 Pa (10 times less compared to the droplet disruption in laminar flow). Nakashima et al. [Nakashima, T.; Shimizu, M.; Kukizaki, M. Membrane emulsification operation manual, Industrial Research Institute of Miyazaki Prefecture, Miyazaki, Japan, 1991] fabricated a particular SPG (Shirasu Porous Glass) membrane composed of Al₂O₃—SiO₂ with a singularly narrow pore size distribution. After moulding the base glass composed of CaO—B₂O₃—Al₂O₃—SiO₂, spinodal decomposition took place in the second heat treatment, and a bicontinuous phase of CaO—B₂O₃ and Al₂O₃—SiO₂ was formed. The CaO—B₂O₃ phase was washed out by acid treatment, and an Al₂O₃—SiO₂ membrane with a narrow pore size distribution remained. They demonstrated that this membrane could provide fine O/W and (W/O)/W emulsions, and a (W/O)/W emulsion of anti carcinogens was one of the successful applications of this technique (“O” means oil, “W” means water)[Higashi, S.; Shimizu, M.; Setoguchi, T.; Preparation of New Lipiodol Emulsion Containing Water Soluble Anti-cancer Agent by Membrane Emulsification Technique. Drug Delivery Systems, 1993, 8, 59-61].

The use of polymer membranes has also been discussed in several references. Polymer films such as PTFE, poly(carbonate), and poly(propylene) can be fabricated as membrane by stretching, accompanied by some heat treatment. Suzuki et al. [Suzuki, K.; Hayakawa, K.; Hagura, Y. Preparation of High Concentration O/W and W/O Emulsions by the Membrane Phase Inversion Emulsification Using PTFE Membranes, Food Sci. Technol. Res. 1999, 5 (2), 234-238] employed hydrophobic and hydrophilic treated PTFE membranes for food processing, and claimed that the O/W and W/0 emulsions with 90% and 84% of dispersed phase, respectively, were successfully produced by a phase inversion emulsification process. Low concentration pre-emulsions of either type (W/O or O/W) were permeated through the membrane corresponding to the type of pre-emulsion (i.e. hydrophilic PTFE for W/O pre-emulsion or hydrophobic for (O/W). Phase inversion took place after the extrusion through the membrane, and the W/O emulsion was converted to O/W or vice versa, and stable high concentration of emulsions were formed. Kawashima et al. [Kawashima, Y.; Hino, T.; Takeuchi, H.; Niwa, T.; Horibe, K. Shear-Induced Phase Inversion and Size Control of Water/Oil/Water Emulsion Droplets with Porous Membrane, J. Colloid Interface Sci. 1991, 145, 512-523] reported a similar phase inversion which occurred when (W/O)/W emulsions were extruded through a poly(carbonate) membrane. Joscelyne and Tragardh [Joscelyne, S. M.; Tragardh, a. Membrane Emulsification—A Literature Review, J.Membrane Sci. 2000, 169, 102-117] have reviewed membrane emulsification using ceramic and glass membranes and have provided a summary of performance by various types of membranes (hydrophilic or hydrophobic), pore size, operational conditions, and so forth. It is a comprehensive review. However, they did not include polymer membranes.

SPG membranes are available as annular cylinders. They are fragile and typically only 1 mm thick (wall thickness). Two sizes are commercially available for laboratory-scale equipment; 2 cm (length)×1 cm (diameter) for the SPG micro-kit which will be illustrated later in FIG. 12A, and 17 cm (length)×1 cm (diameter) for middle scale. Nominal pore sizes are available from 0.1 to 18.0 micrometer [Ise Chemical Co. Commercial Catalog, Ushigome. Shir-ako, Chosei-gun, 299-4202, Japan, 1997].

Details of an apparatus using such membranes are illustrated elsewhere [Omi, S.; Katami, K.; Yamamoto, A.; Iso, M. Synthesis of Polymeric Microspheres Employing SPG Emulsification Technique, J. Appl. Polym. Sci. 1994, 51, 1-11]. The membrane is usually stored in water containing trace amount of surfactant. Just before setting up the apparatus, ultra-sonication treatment and suction (by vacuum) assure the removal of air bubbles remaining in the pores, and the membrane is thoroughly wetted with water. Both ends of the membrane are fixed to a module using a pair of O-rings, and the other connecting parts are assembled pressure-tight. The module is immersed in a beaker containing the continuous phase, illustrated later in FIG. 12A.

Based on the principle shown in FIG. 11, the dispersion phase is gently pushed through a connecting line, to expel the air remaining in the line and module. Then the air vent is closed, and the pressure is raised gradually until the first droplets are released from the pores. This threshold is referred as the critical pressure (Pc). The normal emulsification is carried out at higher pressure than Pc. Yuyama et al. [Yuyama, H.; Watanabe, T.; Nagai, M.; Ma, A. H.; Ami, S., Preparation and Analysis of Uniform Emulsion Droplets Using spa Membrane Emulsification Technique, Colloid and Surfaces, Physicochem. Eng. Aspects 2000, 168, 159-174.] found that there was a finite pressure range in which uniform droplets could be formed. Increasing the pressure further beyond this region will induce jet-like flow of the dispersion phase, and the distribution of droplet sizes becomes broader. From the balance between the applied pressure force and the restraining force, the following relationship will hold at Pc:

Pc=4 Gamma(ow) Cosine(theta)/dm

where Gamma(ow) is the interfacial tension between the oil and the water phase, theta is the contact angle of the droplet on the membrane surface thoroughly wetted with the continuous phase, and dm is the pore diameter.

The relationship between the droplet size and the pore size normally yields a straight line starting from the origin; however, the slope depends on the values of theta and Gamma(ow) as well as the shape of the open-end of the pores.

There are quite a few interesting articles and excellent reviews [Fitch, R. M. Polymer colloids, A comprehensive introduction; Academic Press, San Diego, 1997, 41-46; Sundberg, D. C.; Durant, I. G. Thermodynamics and Kinetic Aspects for Particle Morphology Control In Polymeric Dispersions: Principles and Applications; Asua, J. S., Ed.; Kluwer Academic Publishers: Dordrecht, The Netherlands, 1997, 177-188; Rajatapiti, P.; Dimonie.V:L.; EI-Aasser, M. S. Latex Particle Morphology, The Role of Macromonomers as Compatibilizing Agent In Polymeric Dispersions: Principles and Applications; Asua, J. S., Ed.; Khlwer Academic Publishers: Dordrecht, The Netherlands, 1997, 189-202; Dimonie, V:L.; Daniels, E. S.; Schaffer, O. L.; EI-Aasser, M. S. Control of Particle Morphology In Emulsion Poplymerization and Emulsion Polymers, Chapt. 9; Loveli, P. A.; EI-Aasser, M. S., Eds. John Wiley & Sons, New York, 1997] concerned with the particle morphology and morphology development during emulsion polymerization. Since polymer particles in latex are normally in the sub-micrometer range, sophisticated preparations and characterizations such as the staining one domain in ultra-thin cross-section of particles are required. On the other hand, micron-size droplets prepared from the SFG emulsification provide appropriate space to investigate the particle morphology. Ma et al. [Ma, G.-H.; Nagai, M.; Omi, S. Study on Preparation and Morphology of Uniform Artificial Poly(Styrene)-Poly (Methyl Methllcrylate) Composite Microspheres by Employing SPG (Shirnsu Porous Glass) Membrane Emulsification Technique, J. Colloid Interface. Sci. 1999, 214, 264-282; Ma, G.-H.; Naglli, M.; Ami, S., Effect of Lauryl Alcohol on Morphology of Uniform Poly(Styrene)-Poly(Methyl Methacrylate) Composite Microspheres Prepared by Porous Glass Membrane Emulsification Technique, J. Colloid Interface. Sci. 1999, 219, 110-128; Ma, G.-H.; Nagai, M.; Omi, S. Study on Morphology Control of Uniform Composite Microspheres Prepared by SPG (Shirasu Porous Glass) Membrane Emulsification Technique, Current Topics in Colloid & Interface Science, Research Trends, Trivandrum, India, 2001, in press.]systematically investigated the morphologies of polystyrene and poly(MMA) composite particles obtained from the solvent (DCM) evaporation process. The fourth component, lauryl alcohol (LOR), played the role of compatibilizer between polystyrene and poly(MMA) domains, and yielded core-shell, hemisphere, and reverse core-shell morphologies by changing the compositions among two polymers and LOR. These morphologies are thermodynamically controlled, and the theoretical model for three component morphology proposed by Sundberg and Sundberg [Sundberg, E. I.; Sundberg, D. C. Morphology Development for 3-Component Emulsion Polymer: Theory and Experiment, I. Appl. Polym. Sci. 1993, 47, 1277-1294] was modified so that the model can deal with any combinations of components. The development of particle morphologies during the suspension polymerization, which is considered to be kinetically controlled, was also investigated employing homo- and copolymerizations of styrene, MMA and other acrylates in the presence of inert solvents, polystyrene or poly(MMA) [Omi, S.; Senbn, T.; Nagai, M.; Ma, G.-H. Morphology Development of 10 micron Scale Polymer Particles Prepared by SPG Emulsification and Suspension Polymerization, J. Appl. Polym. Sci. 2001, 79, 2200-2220]. Ma et al. [Ma, G.-H.; Nagai, M.; Omi, S. Study on Preparation of Monodispersed Poly(Styrene-co-N,N′-Dimethylamino-ethyl Methacrylate) Composite Microspheres by SPG, Received: Aug. 10, 2001 Accepted: Oct. 29, 2001; (Shirasu Porous Glass) Emulsification Technique, J. Appl. Polym. Sci. 2001, 79, 2408-2424] also reported that the water-soluble substances added to inhibit the secondary nucleation of polymer particles in the aqueous phase yielded one-eyed particles with different sizes of eye or hollow spheres of poly(styrene-co-dimethylaminoethyl methacrylate, DMAEMA) depending on the inhibitor such as hydroquinone, sodium nitrite, and diaminophenylene. One of the applications developed from these investigations is the synthesis of hollow polystyrene spheres [Chen, A. Preparation of hollow polystyrene particles by glass membrane emulsification technique and suspension polymerization, MS thesis, Tokyo University of Agriculture and Technology, September 2001] and hollow spheres of (meth)acrylate copolymers [Omi, S.; Nagai, M.; Ma, G.-H. Membrane Emulsification—A Versatile Tool for the Synthesis of Polymer Microspheres, Macromol. Symp. 2000, 151, 319-330].

Using the techniques described above, emulsions have been prepared using membrane emulsification. To date, no one has successfully prepared a stable emulsion having uniform droplets greater than one micron in diameter and made of a liquid containing fluorinated organic compounds. One would expect fluorinated organic droplets to coalesce in an aqueous emulsion because of the high density of fluorinated organics relative to water, especially with such large droplet sizes. A liquid fluorinated organic dispersion phase that is uniform and has droplet sizes greater than one micron is highly desirable for many applications.

### SUMMARY OF THE INVENTION

The present invention provides an aqueous emulsion comprising liquid droplets containing more than 30% by weight of fluorinated organic compounds and having an average diameter between about 1 micrometer and about 200 micrometers and having a coefficient of variance less than about 50%, wherein the emulsion is stable. The average diameter is preferably between about 1 micrometer and about 100 micrometers, more preferably between about 1 micrometer and about 50 micrometers, with additional preferred ranges of between 30 and 40 micrometers, between 20 and 30 micrometers, and between 5 and 20 micrometers. The liquid droplets contain more than 30% by weight of partially fluorinated or perfluorinated organic compounds. Preferably, the coefficient of variation is less than about 21%.

In another aspect, the present invention provides an aqueous emulsion comprising liquid droplets of fluorinated organics encapsulated by a polymer, the droplets having an average diameter between about 1 micrometer and about 200 micrometers and having a coefficient of variation less than about 50%, wherein the emulsion is stable. The average diameter is preferably between about 1 micrometer and about 15 micrometers. The coefficient of variation is preferably less than about 30%, more preferably less than about 15%.

In another aspect, the present invention provides a method of forming a stable water-in-oil emulsion having water droplets of an average diameter between about 1 micrometer and about 200 micrometers and having a coefficient of variation less than about 50% comprising passing a water-like substance through a porous polytetrafluoroethylene membrane into an oil. Preferably, the coefficient of variation is less than about 25%. Also preferably, the oil contains at least one fluorinated substance, the porous polytetrafluoroethylene membrane comprises expanded polytetrafluoroethylene, and the water-like substance is a polymerizable hydrophilic monomer. The invention also provides an emulsion product produced according to any of these methods. The water-like substance in this product may be a hydrophilic polymer.

### BRIEF DESCRIPTION OF THE DRAWING

FIG. 1 is a photograph taken through an optical microscope of an emulsion produced by a comparative example for oil-in-water emulsion.

FIG. 2A is a photograph taken through an optical microscope of an emulsion according to an exemplary embodiment of this invention.

FIG. 2B is a magnified view of the emulsion shown in FIG. 1A.

FIG. 3 is a graph showing the relationship between average droplet size and time for emulsions according to exemplary embodiments of this invention.

FIG. 4 is a graph showing the relationship between CV and time for emulsions according to exemplary embodiments of this invention.

FIG. 5 is a graph showing the relationship between average droplet size and membrane pore size for emulsions according to exemplary embodiments of this invention.

FIG. 6A is a photograph taken through a microscope of an emulsion according to exemplary embodiment of this invention.

FIG. 6B is a photograph taken through a microscope of an emulsion according to exemplary embodiment of this invention.

FIG. 7A is a photograph taken through a microscope of an emulsion according to exemplary embodiment of this invention.

FIG. 7B is a photograph taken through a microscope of an emulsion according to exemplary embodiment of this invention.

FIG. 7C is a photograph taken through a microscope of an emulsion according to exemplary embodiment of this invention.

FIG. 7D is a photograph taken through a microscope of an emulsion according to exemplary embodiment of this invention.

FIG. 8A is a photograph taken through a microscope of an emulsion according to exemplary embodiment of this invention.

FIG. 8B is a photograph taken through a microscope an emulsion according to exemplary embodiment of this invention.

FIG. 8C is a photograph taken through a microscope an emulsion according to exemplary embodiment of this invention.

FIG. 8D is a photograph taken through a microscope of an emulsion according to exemplary embodiment of this invention.

FIG. 9A is an SEM of an emulsion according to exemplary embodiment of this invention.

FIG. 9B is an optical micrograph of an emulsion according to exemplary embodiment of this invention.

FIG. 10A is an optical micrograph of an emulsion according to exemplary embodiment of this invention.

FIG. 10B is an SEM of an emulsion according to exemplary embodiment of this invention.

FIG. 11 is a schematic representation of membrane emulsion.

FIG. 12A is an exemplary membrane emulsification unit.

FIG. 12B is an exemplary membrane emulsification unit.

### DETAILED DESCRIPTION OF THE INVENTION

The inventors have surprisingly discovered that stable aqueous emulsions containing liquid fluorinated organic droplets having an average diameter between about 1 micrometer and about 200 micrometers and having a coefficient of variation (“CV”) less than about 50% can be obtained by passing a fluorinated substance through a porous ceramic membrane into the aqueous phase using pressure (referred to herein as “permeation pressure”). This is unexpected because the fluorinated organic compounds have a much higher density that the aqueous phase, and at such large droplet diameters, the fluorinated organic compounds would be expected to coalesce and collapse the emulsion in a very short period of time, such as less than one minute. The emulsions formed by the inventors have remained without collapsing for more than one day. As used herein, an emulsion is “stable” if it does not collapse after at least one day.

The inventors experimented with a number of different membranes in an effort to produce a stable oil-in-water emulsion. One membrane tried by the inventors was porous polytetrafluoroethylene (PTFE). This membrane did not produce a satisfactory oil-in-water emulsion. The preferred membrane discovered by the inventors is a ceramic membrane, such as SPG available from Ise Chemical Co. Ushigome, Shirako, Chosei-gun, 299-4202, Japan.

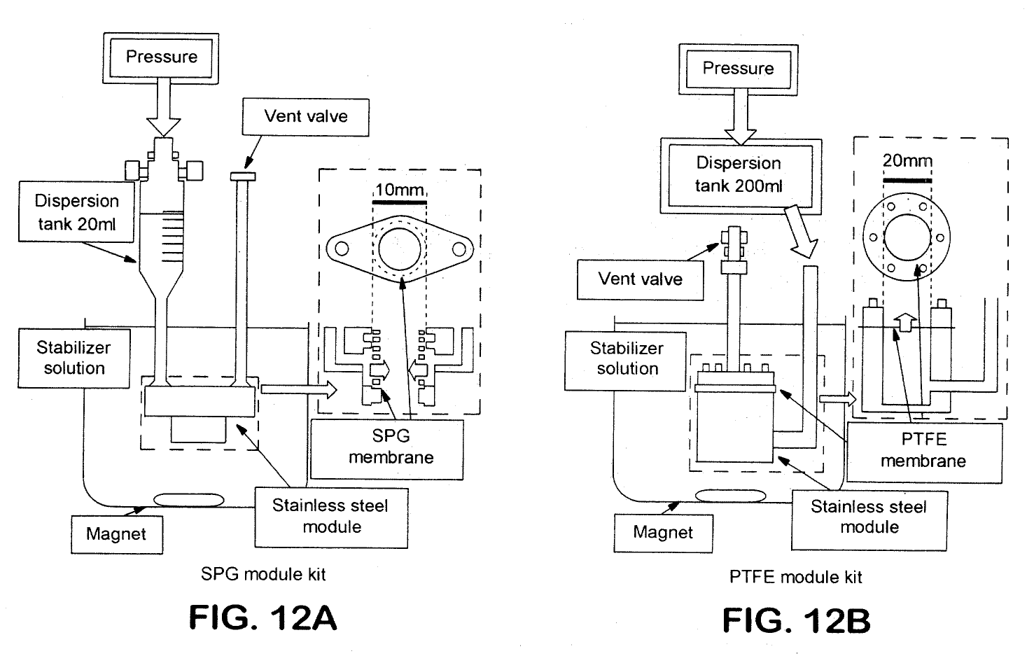

Experimental apparatus for the PTFE membrane emulsification is shown in FIG. 12B. The SPG emulsification kit is shown in FIG. 12A. The effective diameter of the PTFE membrane is 2 cm, the surface area is 3.1 cm², and the hold volume of the dispersion phase is 6.3 cm³. The surface area is approximately the same as that of the SPG membrane. The PTFE membrane was placed on a specially designed punch, and six holes were punched for the bolts and nuts to tighten the flange. The membrane was thoroughly wetted with continuous phase and fixed tightly to the flange with two rubber gaskets clipping the membrane. It is important that the use of stainless steel mesh support is necessary for the PTFE membrane emulsification in order to obtain reproducible results. All the experiments were carried out using a stainless steel mesh support when PTFE membrane is used. The membrane and support were clipped together by two rubber gaskets and fixed to the flange with bolts and nuts. In both cases, the apparatus containing the membrane was immersed in a beaker containing the aqueous phase. The ensuing procedure was as described above. The emulsification was continued until the disperse phase reached 5% by volume in the emulsion. Comparative Example 1 for Oil-in-Water Emulsion and Example 1 illustrate these efforts.

### COMPARATIVE EXAMPLE 1 FOR OIL-IN-WATER EMULSION

An emulsion was formed using a tube made of a porous hydrophilic PTFE membrane having a pore size (reported by supplier Japan Gore-tex, Okayama, Japan) of 1.0 micrometer. An aqueous solution was prepared by mixing a stabilizer of polyvinylalcohol (PVA) in an amount of 6.6 grams, and a surfactant of sodium laurel sulfate in an amount of 0.66 grams in 1-liter distilled deionized water. Only 200 gram of the aqueous solution was used in each experiment as the aqueous (continuous) phase. The oil (dispersion) phase was 8 gram of perfluorodecalin (density=1.908 g/cm³, MW=462). The perfluorodecalin was passed through the PTFE tube at a permeation pressure of 0.75 kilogram-feet per square centimeter.

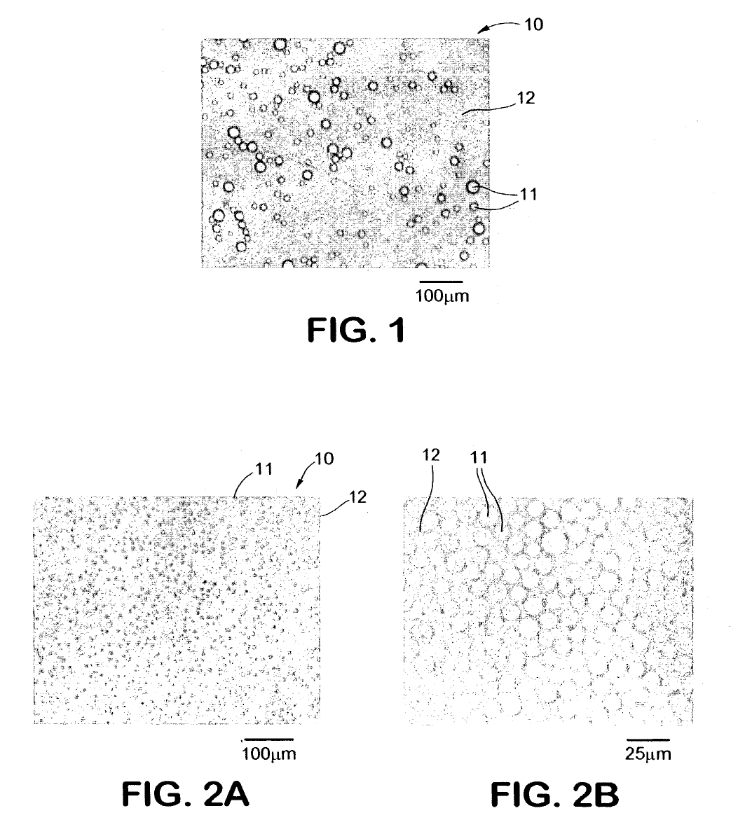

FIG. 1 is a photograph taken through an optical microscope (Olympus, BHC 313) of the emulsion 10 produced by this Comparative Example for Oil-in-Water Emulsion. The oil particles 11 are shown to be scattered throughout aqueous phase 12. Oil particles 11 are not densely packed and they are not uniform in size.

### EXAMPLE 1

An emulsion was formed using a tube made of a porous ceramic SPG membrane having a pore size (reported by supplier) of 1.42 micrometer. The tube was obtained from Ise Chemical Co. An aqueous solution was prepared by mixing a stabilizer of polyvinylalcohol (PVA-217, from Kuraray, DP=1700, degree of saponification=88%) in an amount of 6.6 grams, and a surfactant of sodium laurel sulfate (from Merck, biochemistry grade) in an amount of 0.66 grams in 1-liter distilled deionized water. Only 200 gram of the aqueous solution was used for each experiment as the aqueous (continuous) phase. The oil (dispersion) phase was 8 gram of perfluorodecalin. The perfluorodecalin was passed through the ceramic tube at a permeation pressure of 0.65 kilogram-feet per square centimeter.

FIG. 2A is a photograph taken through an optical microscope (Olympus, BHC 313) of the emulsion 10 produced by this Example 1. The oil particles 11 are shown to be densely packed in aqueous phase 12. Oil particles 11 are also quite uniform in size. This is particularly evident in comparison with the emulsion shown in FIG. 1. FIG. 2B is a magnified view of the emulsion shown in FIG. 1A.

Examples 2-4 below further illustrate the invention but are not intended to limit it in any way. In these examples, the oil phase was HFE-7100 (reported as a partially fluorinated ether compound by 3M and commercially available from 3M) and was present in an amount of 10 milliliters, and the continuous phase was an aqueous solution in an amount of 200 milliliters. The aqueous solution was prepared by mixing 6.65 grams of PVA-217 (from Kuraray, DP=1700, degree of saponification=88%) and 0.67 grams of SLS (sodium lauryl sulfate, from Merck, biochemistry grade) in 1-liter distilled deionized water. In each example, a ceramic SPG membrane was used, but the pore size of the membranes varied.

For characterization of the samples of these examples (and for all such values reported herein), the following analysis was performed. A small amount of sample was taken regularly during the emulsification, and the droplets were observed under an optical microscope (DP-10, Olympus). The diameter of 200 droplets was counted from the photographs to obtain the average diameter (also referred to herein as “droplet size”) and the coefficient of variation (“CV”). The number average diameter was used. The volumetric rate of permeation of oil phase was measured by monitoring the meniscus level of the remaining oil in the tank. The definition of CV is

$$\begin{matrix}CV = \frac{{\sum }_{i}^{} {( \overline{d} - {d}_{i} )}^{2}}{N} ( 100 ) ( \% ) \\ \overline{d} = \frac{{\sum }_{i}^{} {d}_{i}}{N}\end{matrix}$$

N=number of sample, d=droplet size.

| Ex- | | Average | | Emulsi- | | |
|---|---|---|---|---|---|---|
| am- | Membrane | Droplet | | fication | Permeation | |
| ple | Pore Size | Size | CV | Time | Pressure | |
| 2 | 1.42 microns | 10 microns | 11.62% | 60 min | 40.0-45.0 | kPa |
| 3 | 2.80 microns | 27.8 microns | 14.14% | 22 | 39.2 | kPa |

| | | | | | |
|---|---|---|---|---|---|
| 4 | 5.25 microns | 35.1 microns | 10.69% | 125 | 11.0 |

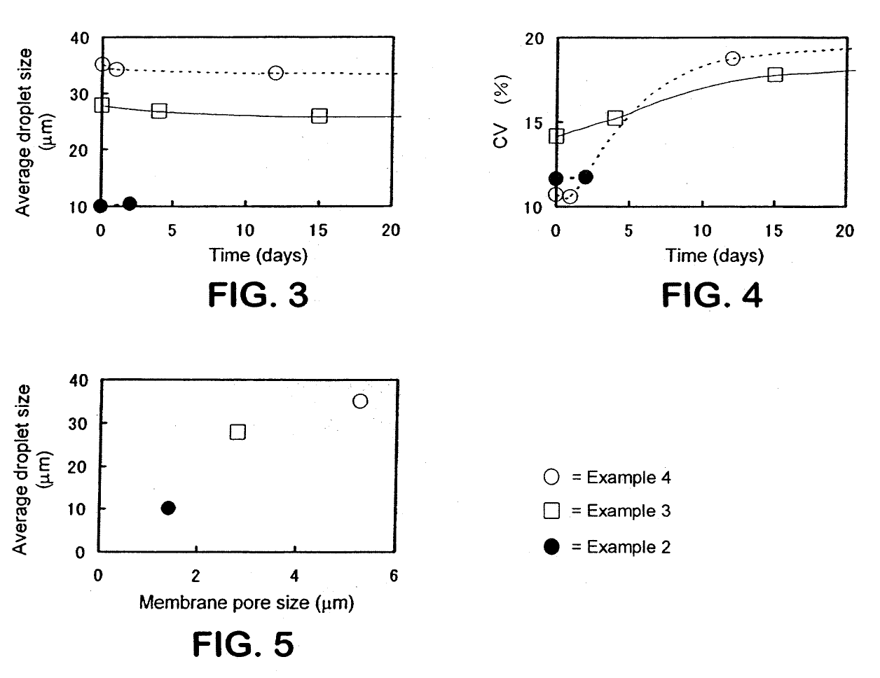

FIG. 3 is a graph showing the relationship between average droplet size and time for Examples 2-4. FIG. 4 is a graph showing the relationship between CV and time for Examples 2-4. FIG. 5 is a graph showing the relationship between average droplet size and membrane pore size for Examples 2-4.

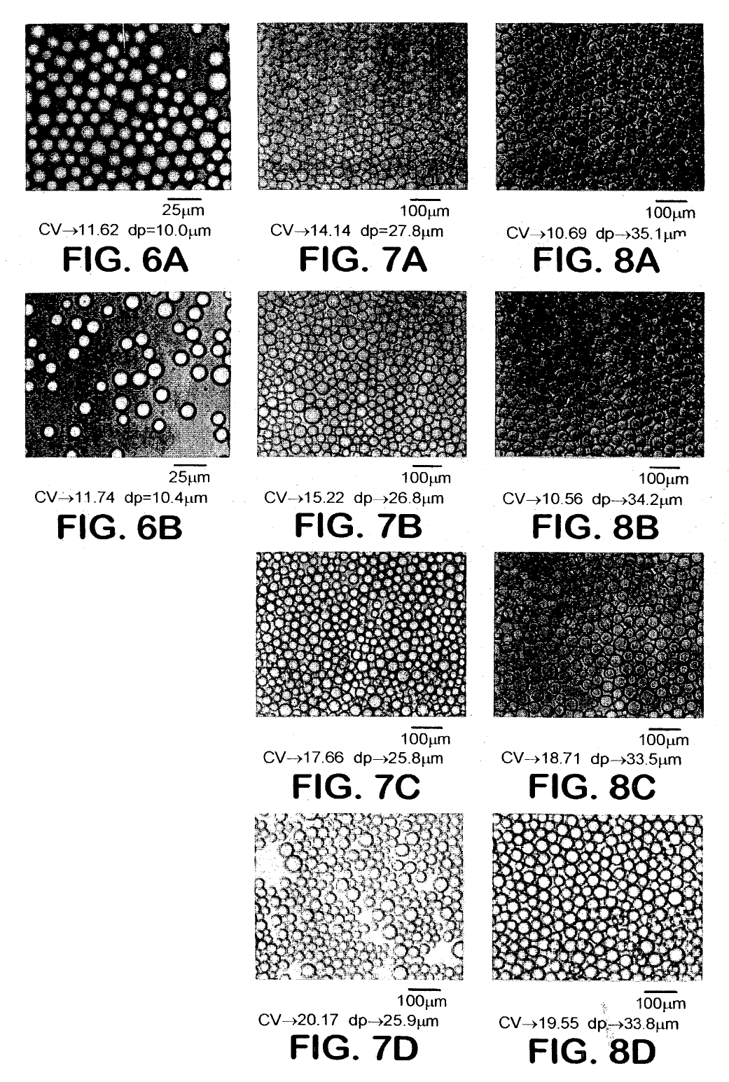

FIG. 6A is a photograph taken through a microscope of the emulsion of Example 2 immediately after emulsification. FIG. 6B is a photograph taken through a microscope of the emulsion of Example 2 showing that it was still stable after 2 days. The CV (%) and droplet diameter dp (in micrometer) are reported for each figure.

FIG. 7A is a photograph taken through a microscope of the emulsion of Example 3 immediately after emulsification. FIG. 7B is a photograph taken through a microscope of the emulsion of Example 3 showing that it was still stable after 1 days. FIG. 7C is a photograph taken through a microscope of the emulsion of Example 3 showing that it was still stable after 14 days. FIG. 7D is a photograph taken through a microscope of the emulsion of Example 3 showing that it was still stable after 81 days. The CV (%) and droplet diameter dp (in micrometer) are reported for each figure.

FIG. 8A is a photograph taken through a microscope of the emulsion of Example 4 immediately after emulsification. FIG. 8B is a photograph taken through a microscope of the emulsion of Example 4 showing that it was still stable after 3 days. FIG. 8C is a photograph taken through a microscope of the emulsion of Example 4 showing that it was still stable after 11 days. FIG. 8D is a photograph taken through a microscope of the emulsion of Example 4 showing that it was still stable after 78 days. The CV (%) and droplet diameter dp (in micrometer) are reported for each figure.

The liquid fluorinated organic compounds described in ths invention can be partially fluorinated or perfluorinated organics with density greater than 1.2 g/cm³ and molecular weight ranges from 100 to 5000, preferrably from 100 to 2000. Examples include but not limited to fluorinated aliphatic or aromatic compounds. The fluorinated organics can be linear, cyclic, or heterocyclic. In addition to carbon and fluorine, the fluorinated organic compounds can further contain hydrogen, oxygen, nitrogen, sulfur, chlorine, bromine atoms.

In another embodiment, the present invention provides emulsions wherein the dispersion phase is fluorinated liquid droplets wherein each droplet is encapsulated in a polymer. Examples 5 and 6 illustrate formation of such an emulsion.

### EXAMPLE 5

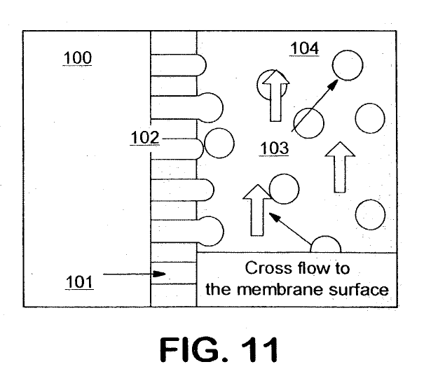

Chemicals were purchased from Wako Pure Chemical Industry Co. Ltd. (reagent grade) unless otherwise stated. 2.00 g polyvinyl pyrrolidone (PVP, MW=40000, Tokyo Kasei Kogyo Co. Ltd.), 0.15 g sodium lauryl sulfate (SLS, biochemistry grade, Merck), 0.10 g anhydrous sodium sulfate and 0.1 g sodium nitrite were dissolved in 225 g distilled and deionized (DDI) water for a continuous phase of an oil-in-water (O/W) emulsion. PVP and SLS are stabilizers, sodium sulfate is an electrolyte, and sodium nitrite is to inhibit a possible polymerization taking place in the aqueous phase. 2.25 g styrene (60 wt. % of monomer phase), 0.7 g of divinyl benzene (20 wt. %, DVB, 55 wt. % ortho and para isomers, 40 wt. % ethylvinylbenzene and 5 wt % saturated derivative), 0.64 g of 2,2,2-trifluoroethylacrylate (17 wt. %, TFEA), 25 mg dimethylaminoethylmethacrylate (1 wt. %, DMAEMA) and 50 mg 2,2′-azobis(2,4-dimethylvaleronitrile) (2 wt. %, ADVN) were mixed in a 30 ml capped bottle as a monomer mixture. 2.14 g HFE-7100 (57 wt. % to the monomer mixture, HFE) was added to the bottle and stirred at 600 rpm with a magnet bar for 10 min for a thorough mixing of the oil phase. An SPG membrane (1 cm O.D×2 cm L×1 mm thickness) with a 1.4 micrometer pore size was soaked in an SLS solution for maintaining wettability with water, and degassed under reduced pressure to remove trapped air in the pores. The membrane was set in a stainless steel module and an emulsification kit was set up. The aqueous solution of the stabilizers was poured in a 300 ml beaker and the SPG emulsification kit was immersed in the solution. A sketch is shown in FIG. 11. The oil phase was put in an oil tank. The aqueous phase was gently stirred with a magnet bar at 300 rpm. The nitrogen pressure was gently applied to the oil tank, and the trapped air in the line was removed from the vent valve. The valve was tightly closed and the pressure was gradually increased until the first droplets were released. This pressure is the critical pressure. The emulsification continued, while maintaining the pressure 10-20 kPa higher than the critical pressure. After the oil phase was emulsified, the emulsion was transferred in a 500 ml round bottom separator flask equipped with a condenser, a nitrogen inlet and outlet, and a half-moon type stirrer. The ingredient was stirred at 176 rpm, and the nitrogen was bubbled in the emulsion to remove dissolved air. After 1 h, the nozzle was lifted from the emulsion and the temperature was raised to 333 K. The polymerization was carried out for 24 h under a blanket of the nitrogen. Before and after the polymerization, the emulsion was observed with an optical microscope (Olympus DP-10) and photographs were taken. 200 monomer droplets or polymer particles were counted for the calculation of the average size and the coefficient of variation (CV) as described above. The particle morphology and the state of encapsulation of HFE were observed with a scanning electron microscope (JEOL, JSM-5310).

The degree of encapsulation of HFE was estimated gravimetrically. 9.1-60 wt. % sucrose solutions were prepared. The density range of these solutions covers 1.03 to 1.32 gcm⁻³. 5 g of the sucrose solutions were put in 10 ml sample bottles, 0.2 g of the dried capsules were added, and allowed to stand for 4 days. If the capsules settled, it means that the density of the capsules is heavier than the reference sucrose solution. If the capsules settled in one of the reference solutions but floated in another, then the density of the capsules will fall between those of the two reference solutions.

Meanwhile, the density of capsules can be theoretically expressed as follows:

$${ρ}_{c} = \frac{\begin{matrix}( wt . \% of total monomer + wt . \% of initiator ) \\ ( 1.045 ) + ( wt . \% of HFE ) ( 1.52 )\end{matrix}}{100} \qquad ( 1 )$$

1.045 is the density of the polymer wall estimated from the particles prepared without HFE. 1.52 is the density of HFE. The wt. % was based on the total weight of the oil phase mixed before the emulsification.

The obtained microcapsules were ellipsoids with 11.7 micrometer longer axis and the coefficient of variation (CV) 12.2%. The estimated density was 1.32 g cm⁻³.

| HFE-7100 | Monomer | Droplet Size^{a} | CV^{a} | Droplet Size^{b} | CV^{b} |
|---|---|---|---|---|---|
| 57 wt % | 43 wt % | 8.81 microns | 9.09% | 11.66 | 12.15% |

^{a}Before polymerization
^{b}After polymerization

### EXAMPLE 6

The percentage of HFE to the total monomer phase was increased to 83 wt. % (3.1 g). The other recipe and reaction conditions were same as those of Example 5. The average diameter was 7.28 micrometer with 11.5% CV. The shape was a spheroid. The estimated density was 1.42 g cm⁻³. However, the capsule wall was rather thin and probably soft. The SEM photographs depicted a honeycomb-like structure.

| HFE-7100 | Monomer | Droplet Size^{a} | CV^{a} | Droplet Size^{b} | CV^{b} |
|---|---|---|---|---|---|
| 83 wt % | 17 wt % | 8.63 microns | 9.2% | 7.28 | 11.5% |

^{a}Before polymerization
^{b}After polymerization

### EXAMPLE 7

0.10 g of lauroyl peroxide was used instead of 50 mg of ADVN. 46 wt. % of HFE based on the total monomer weight was added. The polymerization time was 60 h. The other recipe and reaction conditions were same as Example 5.

The microcapsules were spheres with several dents on the surface. The average diameter was 8.07 micrometer with 10.6% CV. The estimated density was 1.26 g cm⁻³.

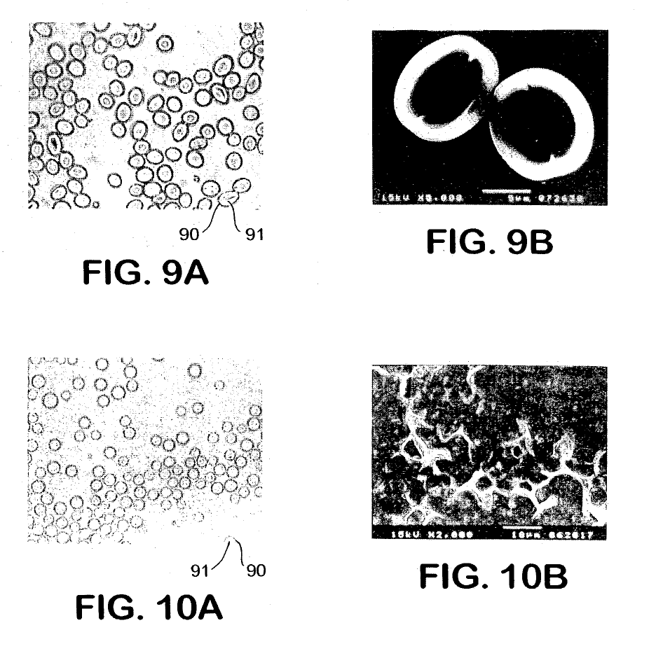

FIG. 9A is an optical micrograph of the emulsion of Example 5 which illustrates the encapsulation. Shell 90 can be seen around liquid droplet 91. FIG. 9B is an SEM at higher magnification of the same sample.

FIG. 10A is an optical micrograph of the emulsion of Example 6 which illustrates the encapsulation. Shell 90 can be seen around liquid droplet 91. FIG. 10B is an SEM at higher magnification of the same sample.

In still another embodiment of the present invention, the inventors have discovered that a porous PTFE membrane can be used to form a water in oil (as opposed to oil in water) emulsion that is as uniform and stable as a water in oil emulsion formed using a ceramic membrane. To form a water in oil emulsion using a ceramic membrane, the membrane must first be treated with a hydrophobic material to coat it. This is an expensive process, and the coating eventually wear off and the membrane must be cleaned and recoated, adding additional cost. The inventor's discovery that porous PTFE can be used to form water in oil emulsions greatly reduces the cost of forming the emulsions. Expanded PTFE is the preferred porous PTFE used to form the water in oil emulsions. Examples 8 and 9 illustrate the formation of water in oil emulsions using porous PTFE membranes.

Porous hydrophobic PTFE membrane obtained from Japan Gore-tex was used for these experiments. The pore size of the PTFE membrane was reported to be 0.5 micrometer by the supplier. In both Examples 8 and 9, 9 gram of 3% sodium chloride in water solution was permeated through the porous PTFE membrane at a permeation pressure about 0.60 Kg/cm². The continuous phase in Example 8 is 95 gram of kerosene with 5 gram of surfactant (Span 85 from ICI). The continuous phase in Example 9 is 95 gram of kerosene with 2.5 gram of Span 85 and 2.5 gram of HFE-7100 (a partially fluorinated liquid from 3M). The emulsification process went very smoothly and the average droplet diameter and CV(coefficient of variation) are reported below.

### EXAMPLE 8

average diameter=2.56 micrometer CV=17.86

### EXAMPLE 9

average diameter=3.12 micrometer CV=10.95

It is to our surprise that in both cases uniform droplet sizes were obtained as opposed to Comparative Example 1. More surprisingly, a small amount of fluorinated substance, preferably a fluorinated liquid, added to the oil phase improves the uniformity of liquid droplets, as indicated by much smaller CV. The liquid droplets may be any water-like substance, defined herein to be a substance that is at least 50% water with the remainder being hydrophilic components soluble in water.

It is also possible to polymerize a hydrophilic monomer in the water phase of the water-in-oil emulsions, as shown in the following example:

### EXAMPLE 10

(Polyacrylamide Crosslinked Hydrogel Particles)

Continuous phase: 135 mil of cyclohexane+65 ml of hexane+5.25 gram of Span 60 from ICI.

Dispersion phase: 18 gram of deionized water+10 gram of acrylamide+2 gram of methylenebisacrylamide+0.06 gram of ammonium persulfate as a free radical initiator. Porous PTFE membrane pore size is reported by the supplier to be 1 micrometer. Permeation pressure was 0.1 Kg/cm². Polymerization occued at 323 K for 24 hours.

Results: Average particle diameter=5.73 micrometer with CV=19.1%.

The examples and specific embodiments presented herein are intended to illustrate the invention but not to limit it in any way. Rather, the scope of the present invention is embraced by the following claims.

What is claimed is:

1. An aqueous emulsion comprising liquid droplets containing more than 30% by weight of fluorinated organic compounds and having an average diameter between about 1 micrometer and about 200 micrometers and having a coefficient of variation less than about 50%, wherein the emulsion is stable.

2. An aqueous emulsion as defined in claim 1 wherein said average diameter is between about 1 micrometer and about 100 micrometers.

3. An aqueous emulsion as defined in claim 1 wherein said average diameter is between about 1 micrometer and about 50 micrometers.

4. An aqueous emulsion as defined in claim 1 wherein said average diameter is between 30 and 40 micrometers.

5. An aqueous emulsion as defined in claim 1 wherein said average diameter is between 20 and 30 micrometers.

6. An aqueous emulsion as defined in claim 1 wherein said average diameter is between 5 and 20 micrometers.

7. An aqueous emulsion as defined in claim 1 wherein said fluorinated liquid droplets are partially fluorinated.

8. An aqueous emulsion as defined in claim 1 wherein said fluorinated liquid droplets are perfluorinated.

9. An aqueous emulsion as defined in claim 1 wherein said coefficient of variation is less than about 21%.

10. An aqueous emulsion comprising liquid droplets of fluorinated organic compounds encapsulated by a polymer, said droplets having an average diameter between about 1 micrometer and about 200 micrometers and having a coefficient of variation less than about 50%, wherein the emulsion is stable.

11. An aqueous emulsion as defined in claim 10 wherein said average diameter is between about 1 micrometer and about 15 micrometers.

12. An aqueous emulsion as defined in claim 10 wherein said coefficient of variation is less than about 30%.

13. An aqueous emulsion as defined in claim 10 wherein said coefficient of variation is less than about 15%.

14. An aqueous emulsion as defined in claim 10 wherein said fluorinated liquid is present in a weight ratio of about 11% relative to said polymer.

15. An aqueous emulsion as defined in claim 10 wherein said fluorinated liquid is present in a weight ratio of about 57% relative to said polymer.

16. An aqueous emulsion as defined in claim 10 wherein said fluorinated liquid is present in a weight ratio of about 83% relative to said polymer.

17. A method of forming a stable water-in-oil emulsion having water droplets of an average diameter between about 1 micrometer and about 200 micrometers and having a coefficient of variation less than about 50% comprising passing a water-like substance through a porous polytetrafluoroethylene membrane into an oil.

18. An water-in-oil emulsion as defined in claim 17 wherein said coefficient of variation is less than about 25%.

19. An water-in-oil emulsion as defined in claim 17 wherein said oil contains at least one fluorinated substance.

20. A method as defined in claim 17 wherein said porous polytetrafluoroethylene membrane comprises expanded polytetrafluoroethylene.

21. A method as defined in claim 17 wherein said water-like substance is a polymerizable hydrophilic monomer.

22. The product produced by the method of claim 17.

23. The product as defined in claim 22 wherein said water-like substance is a hydrophilic polymer.

24. An aqueous emulsion as defined in claim 1 wherein said emulsion is stable for at least 78 days.

25. An aqueous emulsion as defined in claim 1 wherein said emulsion is stable for at least 81 days.
